(19) United States
(12) Patent Application Publication
(10) Pub. No.: US 2004/0035063 A1
(43) Pub. Date: Feb. 26, 2004

(54) Decorative basement window well shield

(76) Inventors: David L. Bryant, Thornton, CO (US); Brent Flot, Lafayette, CO (US)

Correspondence Address: LATHROP & GAGE LC, 4845 PEARL EAST CIRCLE, SUITE 300, BOULDER, CO, 80301, US

(21) Appl. No.: 10/226,423

(22) Filed: Aug. 23, 2002

(51) Int. Cl. E06B 5/02; E04F 17/06; E04C 1/00; B44F 7/00; B44F 9/00

(52) U.S. Cl. 52/107; 52/314; 52/315

(57) ABSTRACT

A window well shield contains a substrate that is laminated to a molded material bearing a decorative design, such as a sculpture or an artificial rock face. The decorative design may be molded to contain functional features, such as egress steps. A waterfall may be provided to cascade down the artificial rock face.

### FIELD OF THE INVENTION

This invention pertains to decorative articles for use in a window well, such as may be found surrounding basement windows in a residential dwelling. More specifically, the decorative articles are laminates including a sheath with a decorative design overlay.

### DESCRIPTION OF THE RELATED ART

It is common practice in many geographic locations to provide basements when building residential and commercial structures. According to this practice, earth moving equipment is used to dig a large hole about one story deep. Forms are constructed inside the hole, and concrete is poured to establish the walls and floor of the basement. In areas with unstable soils, the floor may be framed and constructed of wood, as opposed to pouring a concrete floor. The walls rise upwardly from the floor and serve as the foundation of the house. Additional stories are constructed on top of the basement walls. The basement may serve as a total foundation for the house, or as a partial foundation where part of the upper house does not reside over the basement.

The basements built as described above are dark and dingy places. The below-ground location makes natural lighting difficult. To address this problem, the basement walls may be poured to create windows, or windows may be cut through the walls using a cement saw. In many cities, residential building codes mandate that basements must have windows and that they must be of sufficient size to permit ingress and egress, for example, to permit escape from the basement in case of fire. The basement windows look out into wells, which are hollowed out from the earth and reinforced with a well-shield to prevent the earth from collapsing into the window. The well shield is itself sometimes called a window well; however, the well is actually just empty space. Terminology used herein maintains a distinction between the well shield and the well space.

It is frequently the case that basements are built-out or remodeled to convert the basement space into living area for a home, or for additional workspace in a commercial office building. In a normal above-ground structure, windows permit the occupants to look outside. In basements, the occupants are only able to look out into the basement window wells where they see the well shield, for example, a cement surface or one of corrugated sheet metal. This view is ugly and does not change over time.

There have been some attempts to decorate well shields in a manner that makes the view more inviting. U.S. Pat. No. 5,881,503 describes a decorative window well having a shield that contains a plurality of planter pockets that are designed to receive plants. Problems with this design include the watering of plants in these wells, which tends to splash mud droplets on the adjacent window. Furthermore, the well space is normally not heated, so the plants die in the winter making the view even more unappealing. U.S. Pat. No. 5,647,154 shows a flexible sheet that contains a design, such as a picture with a rural motif. The sheet may be inserted into the well shield where it is clipped in place. The sheet may be renewed from time to time if it is damaged or become uninteresting. Generally, the sheet appears to be what it is, namely, an inexpensive plastic design haphazardly stuck in a window well. It is not suited for use in upscale homes or offices.

### SUMMARY OF THE INVENTION

The present invention overcomes the problems that are outlined above and advances the art by providing an extremely durable decorative window well shield of laminated construction having a pleasing look and feel.

The decorative basement window well shield may include a substrate that is formed in a predetermined shape to function as a window well shield. The substrate presents an inner surface that is bonded to a molded material, such as cement or a synthetic resin. The outer side of the molded material is bonded to the inner surface of the substrate to form a laminate. An inner side of the molded material presents a three dimensional design, for example, one having the appearance of a natural rock surface or a sculpture.

The substrate may comprise any material, such as plastic, metal or wood. Corrugated sheet metal is preferred.

The window well shield may be used alone as a primary window well shield or as a decorative skirt within a second window well shield. Use of the window well shield as a decorative skirt permits decorative retrofitting of an installed window well shield.

The decorative design may be provided with functional features, such as a plurality of egress steps that are built into the three dimensional design. A water circulation system may be provided to produce a waterfall cascading over the three dimensional design.

The window well shield is made using a process, for example, comprising the steps of:

preparing a moldable material;

applying the moldable material to a window well shield and a mold, the mold having a three dimensional design;

permitting the moldable material to harden and bond to the window well shield, which forms a molded material bonded to the window well shield; and

detaching the molded material from the mold to form the decorative e window well shield.

### BRIEF DESCRIPTION OF THE DRAWINGS

FIG. 1 is an isometric view of a decorative window well shield deployed as a skirt within a second window well shield;

FIG. 2 is an assembly view of the assembly shown in FIG. 1;

FIG. 3 depicts the decorative window well shield from inside a basement window; and

FIG. 4 shows the structural components of a molding assembly used to make the decorative window well shield.

### DETAILED DESCRIPTION

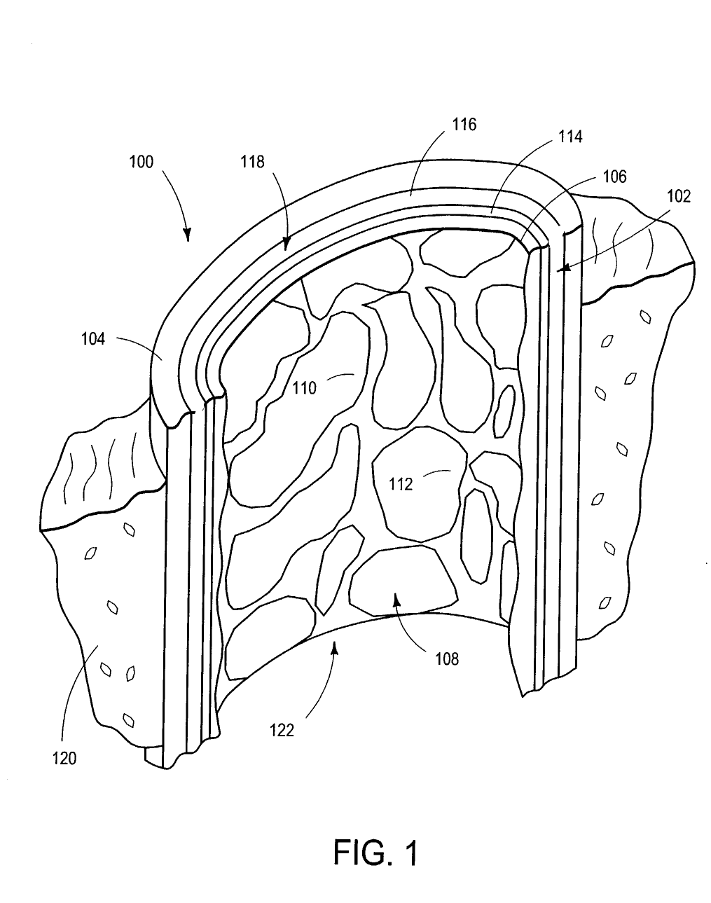

There will now be shown by way of example, and not by limitation, a decorative basement window well shield of laminated construction that includes a substrate formed in a predetermined shape to function as a window well shield. FIG. 1 is an isometric view of a window well shield assembly 100 including a first or inner window well shield 102 and an optional second or outer window well shield 104. The inner window well shield 102 contains an innermost layer 106 that is formed of a molded material, such as cast cement or a cast synthetic resin. The innermost surface 108 presents a molded or cast three dimensional design. The design may be a surface 108 appearing to be a natural rock surface, for example, including contoured bumps 110 and 112. On an outer side (not shown) of the molded material 106 that is remote from the innermost surface 108, the molded material 106 is bonded to a substrate 114. The substrate 114 may be made of corrugated sheet metal bent or formed in the general shape of a window well shield. As shown in FIG. 1, the inner window well shield 102 is positioned as a skirt having predetermined dimensions that fit within an inner wall 116 of the outer window well shield 104.

The outer window well shield 104 may have any dimension or shape, and is shown in FIG. 1 as having a semi-ovaloid cross-sectional shape. Alternative cross-sectional shapes may include, for example, partial right rectangular boxes, partial hexagons, partial octagons, semi-circles, and any other shape that is commonly used for window well shields. The substrate 114 may conform precisely to these dimensions or be constructed to provide a space 118 between the substrate 114 and the inner wall 116. The outer window well shield 104 is usually buried in the ground 120 to prevent collapse of earth into the interior space 122. The respective window well shields 102 or 104 may also be used above ground, for example, to provide a security barrier. The outer window well shield 104 is not required, and the inner window well shield 102 may be used as the sole window well shield.

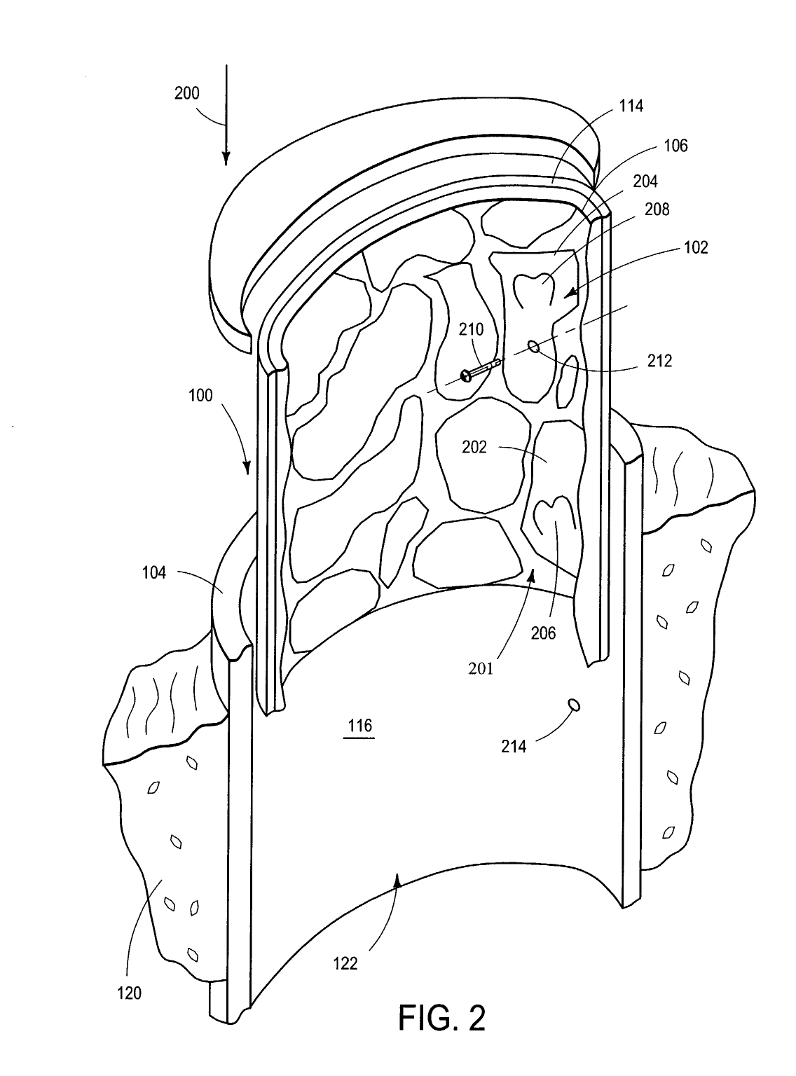

FIG. 2 is an assembly view of the window well shield assembly 100. In FIG. 2, like numbering has been retained for identical items with respect to FIG. 1. The inner shield 102 is shown sliding downwardly in the direction of arrow 200 and into the space 122 within inner wall 116. The innermost face 201 has a different three dimensional design than does the innermost face 108 shown in FIG. 1. Artificial boulders 202 and 204 are provided with molded egress steps 206 and 208, which permit a person to climb in and out of space 122. A lag screw 210 is shown positioned for insertion into hole 212 through the inner window well shield 102. The lag screw 210 will eventually reside within lag nut 214 within the second window well shield 104. The use of fasteners like lag nut 214 optionally imparts stability to the inner window well shield 102, for example, to sustain the weight of a person climbing on steps 206 and 208. Once fully in position, the exposed head of lag nut 214 may be covered, for example, with a concrete patch that matches the color and texture of the molded material 106.

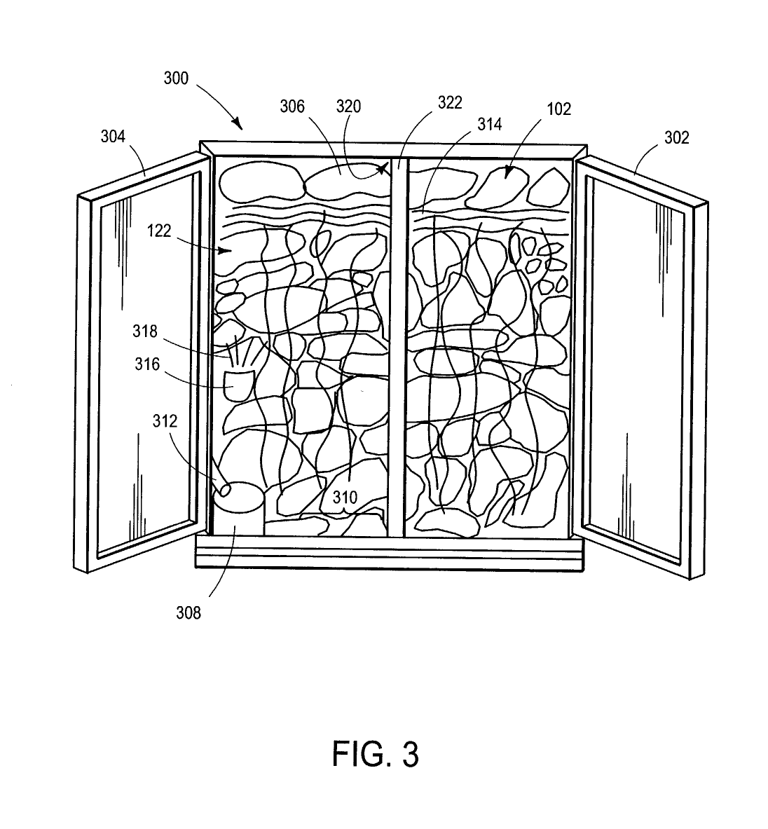

FIG. 3 is an inner elevational view of a basement window 300 from which is visible an inner window well shield 102. Hingedly mounted windowpane members 302 and 304 are pivoted open to provide direct access to the inner window well shield 102. an innermost surface 306 differs in three dimensional layout from the innermost surfaces 108 and 201, respectively shown in FIGS. 1 and 2, to provide yet another artificial rock face design. Additionally, a water circulation pump 308 circulates water from a collection pan 310 through hose 312 and onto ledge 314 for cascade down the innermost surface 306. A pot receptacle 316 may contain a plant 318. A cover (not shown) in region 320 may seal space 122 and convert the basement window 300 into a terrarium that may be selectively isolated by closure of windowpane members 302 and 304 against a middle brace 322.

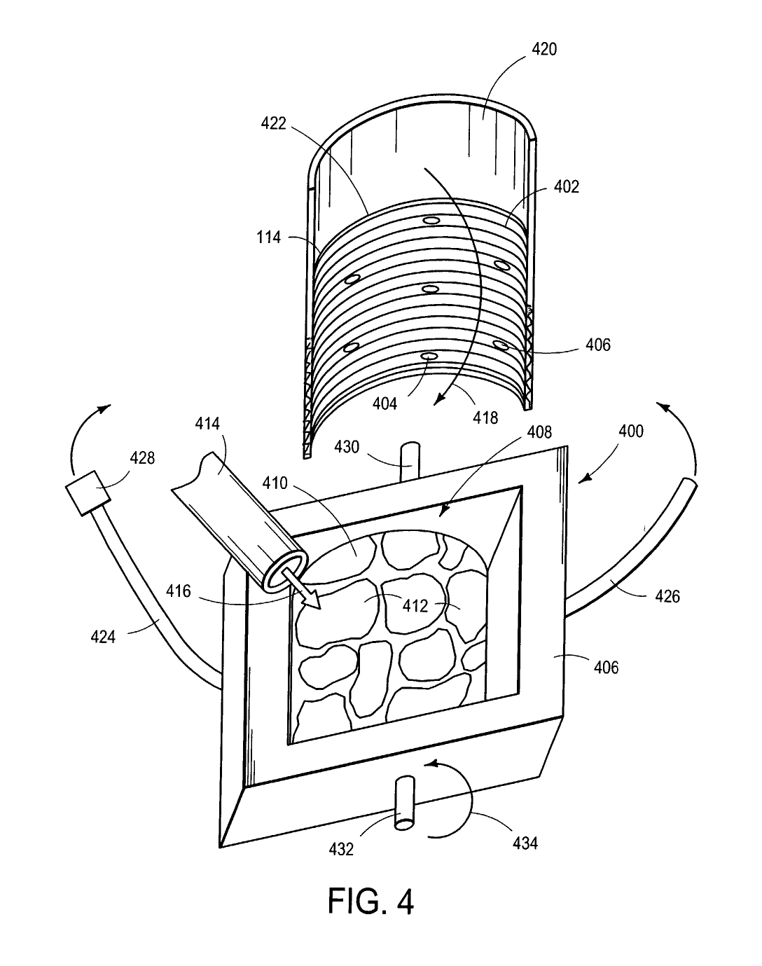

FIG. 4 illustrates a molding assembly 400 for use in making the inner window well shield 102 shown in FIGS. 1-3. The substrate 114 may be corrugated sheet metal presenting an inner corrugated wall 402 with, optionally, a plurality of apertures, such as apertures 404 and 406. The substrate 114 has the general dimensions of a conventional window well shield. A mold block 406 contains a receptacle 408 including an elastomeric casting 410 with surface 412 forming an impression taken from a natural rock face. Surface 412 is generally contoured to meet the dimensions of the inner corrugated wall 402, permitting the molded material 106 (not shown) to reside therebetween.

A dispenser 414 is used to deliver thixotropic moldable material 416, e.g., cement or synthetic resin, which is manipulated by hand or by machine to coat surface 412. The substrate 114 is pivoted along pathway 418 onto the moldable material over surface 412, as is a backing plate 420 that is complementary to the rearward portion 422 of substrate 114. The assembly is strapped in place using straps 424 and 426, which are fastened using buckle 428. Axles 430 and 432 may be braced for spinning of the assembly, e.g., counterclockwise as shown by arrow 434, which improves distribution and bonding of the moldable material 416 against the inner corrugated wall 402. The optional apertures 404 and 406 permit trapped air to bleed. The moldable material is given time to cure or harden, after which time the straps 424 and 426 are unbuckled. The backing plate 420 is removed, and the completed inner window well shield 102 is lifted for detachment from surface 412.

Various chemical agents may be used to enhance results from this molding process. The inner corrugated surface 402 may be coated with a bonding agent or even painted prior to positioning against the moldable material 416. The moldable material may be provided with texturing agents, e.g., pebbles or sand, as well as coloring agents. Coating of surface 412 with a compatible release agent prior to pouring the moldable material 416 facilitates this detachment.

The foregoing discussion is intended to illustrate the concepts of the invention by way of example with emphasis upon the preferred embodiments and instrumentalities. Accordingly, the disclosed embodiments and instrumentalities are not exhaustive of all options or mannerisms for practicing the disclosed principles of the invention. The inventor hereby states his intention to rely upon the Doctrine of Equivalents in protecting the full scope and spirit of the invention.

I claim:

1. A decorative basement window well shield comprising:
a substrate formed in a predetermined shape to function as a window well shield, the substrate presenting an inner surface; and
a molded material having an outer side bonded to the inner surface of the substrate and an inner side having a three dimensional design.

2. The decorative basement window well shield of claim 1, wherein the substrate comprises corrugated sheet metal.

3. The decorative basement window well shield of claim 1, wherein the three dimensional design comprises a surface having an appearance of natural rock.

4. The decorative basement window well shield of claim 1, wherein the three dimensional design comprises a sculpture.

5. The decorative basement window well shield of claim 1, wherein the molder material comprises cement.

6. The decorative basement window well shield of claim 1, wherein the molded material comprises a synthetic resin.

7. The decorative basement window well shield of claim 1, wherein the molded material is bonded directly to the substrate.

8. The decorative basement window well shield of claim 1, wherein the molded material is bonded to the substrate through an intermediate bonding agent.

9. The decorative basement window well shield of claim 1, further comprising the substrate positioned as a skirt within a second window well shield.

10. The decorative basement window well shield of claim 1, further comprising a plurality of egress steps built into the three dimensional design.

11. The decorative basement window well shield of claim 1, further comprising means for providing a waterfall over the three dimensional design.

12. A method of making a decorative window well shield, the method comprising the steps of:
preparing a moldable material;
applying the moldable material to a window well shield and a mold, the mold having a three dimensional design;
permitting the moldable material to harden and bond to the window well shield, which forms a molded material bonded to the window well shield; and
releasing the molded material from the mold to form the decorative e window well shield.

13. the method of claim 12, further comprising the step of inserting the decorative window well shield into a window well space.
